(19) United States
(12) Patent Application Publication
(10) Pub. No.: US 2023/0230005 A1
(43) Pub. Date: Jul. 20, 2023

(54) DISCOUNT PREDICTIONS FOR CLOUD SERVICES

(71) Applicant: VMWARE, INC., Palo Alto, CA (US)

(72) Inventors: YASH BHATNAGAR, Bangalore (IN); MAGESHWARAN RAJENDRAN, Bangalore (IN); KEERTHANAA K, Bangalore (IN); GURU RAJ VAISHNAV AKUTHOTA, Hyderabad (IN); NEERAJ MENON S, Bangalore (IN)

(21) Appl. No.: 17/699,214

(22) Filed: Mar. 21, 2022

(30) Foreign Application Priority Data
Jan. 17, 2022 (IN) 202241002717

(51) Int. Cl. G06Q 10/06; G06Q 30/02; G06N 5/04; G06N 5/02

(52) U.S. Cl. CPC G06Q 10/06315; G06Q 10/06375; G06Q 30/0215; G06N 5/04; G06N 5/025

(57) ABSTRACT

In an example, a cloud service management node includes a knowledge base having a plurality of billing rules for a cloud computing environment, a processor, and a memory coupled to the processor. The memory may include a discount predictor module to receive an actual bill related to consumption of a cloud service in the cloud computing environment. Further, the discount predictor module may determine a variation between the actual bill and an expected cost from a public rate card by comparing the actual bill with the expected cost. Furthermore, the discount predictor module may evaluate the plurality of billing rules to predict a discount type and a discount associated with the discount type that matches the variation between the actual bill and the expected cost from the public rate card. Further, the discount predictor module may output the discount type and the discount on an interactive user interface.

### RELATED APPLICATION

Benefit is claimed under 35 U.S.C. 119(a)-(d) to Foreign Application Serial No. 202241002717 filed in India entitled “DISCOUNT PREDICTIONS FOR CLOUD SERVICES”, on Jan. 17, 2022, by VMware, Inc., which is herein incorporated in its entirety by reference for all purposes.

### TECHNICAL FIELD

The present disclosure relates to computing environments, and more particularly to methods, techniques, and systems for predicting a discount for consumption of a cloud service in a cloud computing environment.

### BACKGROUND

Cloud service providers such as Amazon Web Services® (AWS), Microsoft Azure®, Google Cloud Platform™, Oracle Cloud™ Infrastructure, VMware Cloud™ on AWS, and the like provide enterprise customers with multiple ways to consume cloud services based on enterprise operation needs. Further, the price for such cloud services may depend on various parameters such as a region, an operating system, an instance family, a tenancy, an off-peak use, whether an enterprise has committed to a reserved level of utilization, and the like. Furthermore, the cloud service providers may provide the enterprise customers with discounted pricing for the cloud services based on a volume (i.e., consumption) commitment, for instance. The discounts (also referred to as enterprise discounts) may be specific to each enterprise and may be based on factors such as a customer size, potential spends, and the like.

### BRIEF DESCRIPTION OF THE DRAWINGS

FIG. 1A is a block diagram of an example system, depicting a discount predictor module to predict a discount corresponding to consumption of a cloud service;

FIG. 1B is a block diagram of the example system of FIG. 1A, depicting additional features;

FIG. 2 is a block diagram of another example system, depicting a discount mapper to predict a discount corresponding to consumption of a cloud service;

FIG. 3A shows an example graphical representation of a fixed public rate and a tiered discount rate;

FIG. 3B shows an example graphical representation of a variable public rate and tiered discount rate;

FIG. 4 is a flow diagram, illustrating an example computer-implemented method for predicting a discount type and a discount for a cloud service;

FIGS. 5A-5H are graphical user interfaces, depicting an example implementation to determine an enterprise discount in a cloud service management platform for customers with actual bills generated inclusive of discounts; and

FIG. 6 is a block diagram of an example computing node including non-transitory computer-readable storage medium storing instructions to predict at least one candidate billing rule and an associated discount value.

The drawings described herein are for illustration purposes and are not intended to limit the scope of the present subject matter in any way.

### DETAILED DESCRIPTION

The paragraphs [0011] to [0018] describe about an overview of cloud services provided by cloud service providers in a cloud computing environment, existing cloud bill processing systems to get information about cloud infrastructure and billed costs associated with the cloud services, and drawbacks associated with the existing cloud bill processing systems. The cloud computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). The cloud computing environment may be a virtual representation of the physical data center, complete with servers, storage clusters, and networking components, all of which may reside in a virtual space being hosted by one or more physical data centers. Further, the cloud services may be infrastructure, platforms, or software that are hosted by the cloud service providers (e.g., Amazon Web Services (AWS), Microsoft Azure, and the like) in the cloud computing environment and made available to customers through the Internet.

In such cloud computing environments, the cloud service providers may offer different pricing for different customers (e.g., enterprises). The cloud service providers may provide discount pricing for the customers based on factors such as customer size, potential spends, and the like. In some examples, the discounts may be specific to each customer. Such discounts may be communicated to the customers upfront, which act like a contract between the cloud service providers and the customers.

In some examples, the discounts may make actual pricing significantly lower than publicly available rates. Customers utilizing cloud service management platforms, such as CloudHealth by VMware, have to be provided with the discounts to be able to get an accurate analysis of the cloud infrastructure. Otherwise, multiple features such as rightsizing, budgeting, and the like may project incorrect values.

The cloud service management platform may refer to a platform that enables customers to visualize, optimize, and govern associated cloud computing environments. The cloud service management platform may collect and consolidate a customer's cloud computing environment data in a single platform to enable the customer to efficiently optimize and govern the cloud computing environment. The cloud service management platform may provide the customer with analysis, recommendations, and trended reporting on cost, usage, performance, and security based on analysis of data related to the customer's cloud-based services use.

Further, the cloud service management platform may include a bill processing system that processes a customer's daily/monthly bills to get information about the cloud infrastructure and billed costs (e.g., cost and usage report (CUR) for AWS) associated with the cloud service. However, the bills may provide usage with the public rates and costs, rather than the discounted rates provided to the customer. To get the discounts, the cloud service management platform may provide an option to the customers to get the enterprise discounts in the bill processing platform manually via a series of customer-engineer interviews to capture configurations (e.g., billing rules). Further, the platform's code base may have to be modified manually to apply the billing rules/configurations, so that the personalized rates are fetched for every calculation within the cloud service management platform for the customer.

Further, the discounts can be of different forms such as a flat percentage discount, discounts tiered into various levels based on usage as well as conditions like geographical region-specific discounts, and the like. Further, different combinations of these forms may also be valid, which can form significantly complex discount rules. In some cases, multiple discount rules can be applicable, in which a cloud service provider specified resolution strategy has to be applied. Accounting such rules in an automated bill processing system may be a significantly complex task as each such rule has to be applied considering usage and other details, along with resolution strategies. Therefore,
as the discounts are specific to a customer, an underlying programming logic (i.e., program code) may have to be written for each customer specifically, with significantly little scope of generalization. When the number of customers increases, accounting of the rules in the automated process may not be scalable.
since the discounts may change over a period of time, multiple rounds of discussions may be required to capture the discounts, which may be a recurrent process. Also, since the discounts require code modifications each time in the bill processing system to get correct values, a considerable amount of time may be required to incorporate the new rules. This translates to a delayed process where the customers may have to wait before the customers get the correct results in the bill processing system.

In other examples, the customers may choose to have the cloud service providers directly reflect the personalized rates in the cost and usage reports. In this example, customer specific rates get automatically picked up by the bill processing systems. However, features such as right sizing, what-if analysis, and the like require rates for exhaustive options (such as possible instance tiers and the like) which may not be available in the usage reports. Such features may still have to rely on the public rate cards in the absence of personalized rates for the customer, which may yield to incorrect results. Therefore, even though the bills include the discounts, the bills may still be required to go over the above-mentioned approach to get the discounts in the bill processing system.

Examples described herein may provide a cloud service management node including a knowledge base having a plurality of billing rules for a cloud computing environment. Further, the cloud service management node may include a discount predictor module. During operation, the discount predictor module may receive an actual bill related to consumption of a cloud service in the cloud computing environment provided by a cloud service provider. Further, the discount predictor module may determine a variation between the actual bill and an expected cost from a public rate card by comparing the actual bill with the expected cost. Furthermore, the discount predictor module may evaluate the plurality of billing rules in the knowledge base to predict a discount type (e.g., flat discount or tiered discount) and a discount (e.g., a discount value) associated with the discount type that matches the variation between the actual bill and the expected cost from the public rate card. Further, the discount predictor module may output the discount type and a discount on an interactive user interface.

Examples described herein provide a self-learning method that discovers enterprise discounts given to a customer by comparing the actual bills against the public rate cards, using the set of billing rules in the cloud service management platform as a knowledge base. Thus, examples described herein provide an automated approach to predict the discounts and hence manual steps such as customer interviews to obtain the discounts can be avoided.

In the following description, for purposes of explanation, numerous specific details are set forth to provide a thorough understanding of the present techniques. It will be apparent, however, to one skilled in the art that the present apparatus, devices, and systems may be practiced without these specific details. Reference in the specification to “an example” or similar language means that a particular feature, structure, or characteristic described is included in at least that one example, but not necessarily in other examples.

System Overview and Examples of Operation

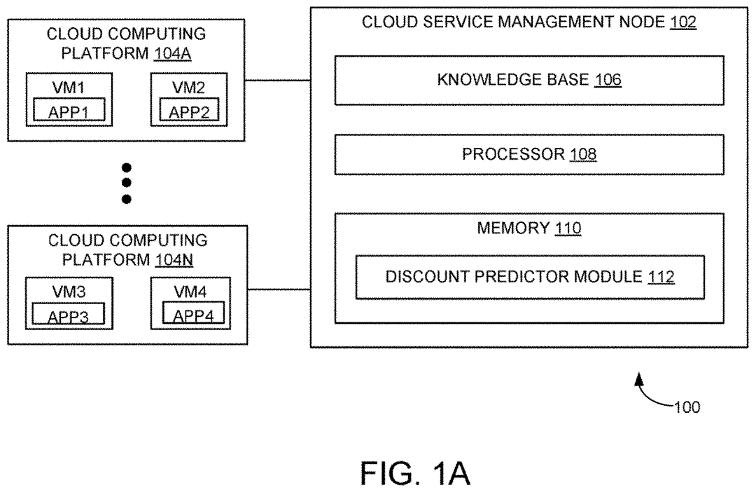

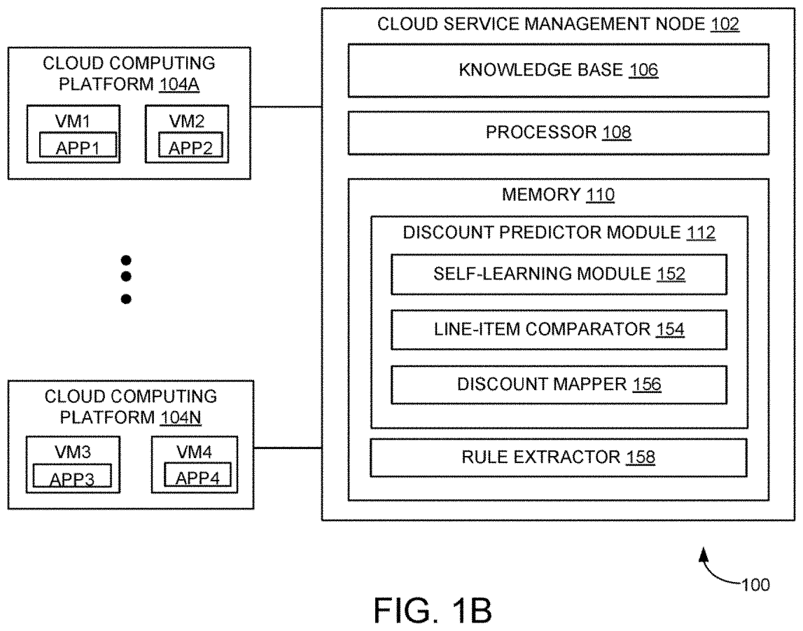

FIG. 1A is a block diagram of an example system 100, depicting a discount predictor module 112 to predict a discount corresponding to consumption of a cloud service. As shown in FIG. 1A, system 100 may include a cloud service management node 102 and cloud computing environments (i.e., cloud computing platforms 104A-104N) that are in communication with cloud service management node 102. Cloud service management node 102 may refer to a computing device or computer program (i.e., executing on the computing device) that enables tenants to visualize, optimize, and govern associated cloud computing platforms 104A-104N. Further, cloud service management node 102 may provide the tenants with analysis, recommendations, and trended reporting on cost, usage, performance, and security based on analysis of data related to the tenant's cloud-based services use. An example cloud service management node 102 may be CloudHealth by Vmware.

Cloud service management node 102 may connect to cloud computing platforms 104A-104N either directly or over a network (e.g., over a local-area network, wide-area network, wireless network, or the like). As shown in FIG. 1A, system 100 may support multiple cloud computing platforms 104A-104N, available to multiple enterprises in single-tenant and multi-tenant configurations. In one example, cloud computing platforms 104A-104N may be provided by different cloud service providers. For example, each cloud computing platform may include, but not limited to, Amazon Web Services (AWS), Google Cloud Platform, Windows Azure, OpenStack, or any other cloud computing platform.

Each of the cloud computing platforms 104A-104N may be operated by a cloud computing service provider and exposed as a service available to tenants (e.g., account holders), such as enterprises. In some examples, cloud computing platforms 104A-104N may be configured to dynamically provide enterprises or users with one or more virtual data centers in which a user may provision VMs, containers, deploy multi-tier applications on VMs and/or containers, and/or execute workloads. Cloud computing platforms 104A-104N may include an infrastructure platform upon which a cloud computing environment may be executed.

As shown in FIG. 1A, VMs (i.e., VM1 to VM4) may be deployed within corresponding cloud computing platforms 104A-104N to provide infrastructure services, information technology (IT) management services, and other infrastructure-related functions to the tenants. Further, the VMs may execute applications (e.g., APP1 to APP4) running therein. Such cloud service providers may offer different pricing for different customers based on parameters such as a region, an operating system, an instance family, a tenancy, an off-peak use, whether an enterprise has committed to a reserved level of utilization, and the like.

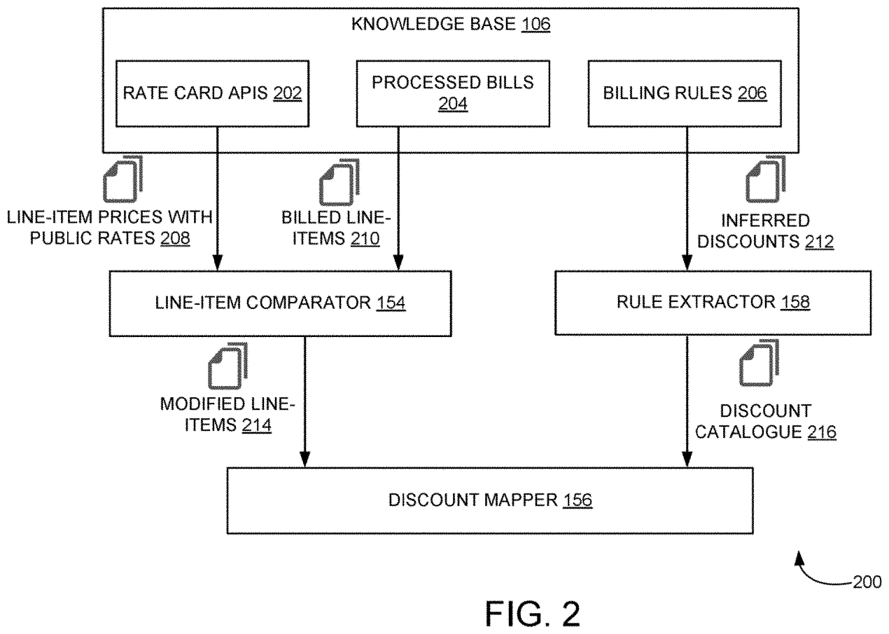

As shown in FIG. 1A, cloud service management node 102 includes a knowledge base 106 including a plurality of billing rules for a cloud computing environment (e.g., cloud computing platform 104A). For example, a cloud service provider may offer a set of cloud services and applications that tenants can consume. For example, the cloud services may be infrastructure, platforms, or software that are hosted by the cloud service providers in the cloud computing environment and made available to users through the Internet. In an example, knowledge base 106 includes details regarding the cloud services, such as rate cards, processed bills, billing rules, and the like. Example content of knowledge base 106 is described in FIG. 2.

Further, cloud service management node 102 includes a processor 108 and a memory 110 coupled to processor 108. In an example, memory 110 includes discount predictor module 112. The term “processor” may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processor 108 may, for example, include single or multiple cores on a chip, multiple cores across multiple chips, multiple cores across multiple devices, or suitable combinations thereof. Processor 108 may be functional to fetch, decode, and execute instructions as described herein.

During operation, discount predictor module 112 may receive an actual bill related to consumption of the cloud service in the cloud computing environment provided by the cloud service provider. Further, discount predictor module 112 may determine a variation between the actual bill and an expected cost from a public rate card by comparing the actual bill with the expected cost. Furthermore, discount predictor module 112 may evaluate the plurality of billing rules in knowledge base 106 to predict a discount type and a discount associated with the discount type that matches the variation between the actual bill and the expected cost from the public rate card.

Further, discount predictor module 112 may output the discount type and the discount on an interactive user interface. In an example, discount predictor module 112 outputs the discount type including a probable discount or multiple probable discounts on the interactive user interface. Furthermore, discount predictor module 112 may receive a user input related to the discount type and/or the discount associated with the discount type via the interactive user interface. The user input may verify or modify the discount type, a value of the discount, or both. Furthermore, discount predictor module 112 may store the modified discount type, the modified discount associated with the discount type, or both as a new billing rule in knowledge base 106. Thus, examples described herein may provide a reactive approach, where the customers/tenants are provided with the interactive user interface to display the probable enterprise discounts. Further, the customers can modify the presented discounts and the modifications may be further used to enhance future discount predictions.

FIG. 1B is a block diagram of example system 100 of FIG. 1A, depicting additional features. For example, similarly named elements of FIG. 1B may be similar in function and/or structure to elements described in FIG. 1A. As shown in FIG. 1B, discount predictor module 112 includes a self-learning module 152, a line-item comparator 154, and a discount mapper 156.

During operation, line-item comparator 154 may perform a line-by-line comparison between the actual bill having discounted line items and the expected cost such that the variation between the actual bill and the expected cost is determined for each of the discounted line items. For example, each of the discounted line items is a row in the actual bill including cost of consumption of an infrastructure object in the cloud service at a granular level. Further, discount mapper 156 may map the variation between the actual bill and the expected cost to a billing rule or a set of the plurality of the billing rules based on the consumption of the cloud service. Furthermore, discount mapper 156 may predict the discount type and the discount associated with the discount type that matches the variation between the actual bill and the expected cost based on the mapping.

In an example, discount mapper 156 evaluates the plurality of billing rules in knowledge base 106 to predict candidate billing rules and associated discount values that match the variations in each of the discounted line items. Further, discount mapper 156 may:
filter billable categories (e.g., host computing system usage, compute resource usage, storage resource usage, data transfer charges, and the like) that have non-zero variations between the actual bill and the expected cost corresponding to the discounted line items,
predict a candidate billing rule that matches each of the filtered billable categories based on a parameter that determines a condition for the discount,
for each candidate billing rule, predict a discount value that is provided by the candidate billing rule to cause the variation based on a discount model, and
predict the discount type and the discount associated with the discount type that matches the variation between the actual bill and the expected cost based on the candidate billing rules and associated discount values associated with each of the discounted line items.

Further, self-learning module 152 may receive a user input to modify the discount type, a value of the discount, or both via the interactive user interface. Further, self-learning module 152 may acquire knowledge from the modified discount type, the modified discount associated with the discount type, or both. Furthermore, self-learning module 152 may utilize the acquired knowledge to predict a future discount type and/or the discount.

In other examples, memory 110 may include a rule extractor 158. During operation, rule extractor 158 may extract historical billing rules defined in a cloud management platform of the cloud computing environment. Further, rule extractor 158 may obtain a parameter that determines a condition for the discount. In an example, the parameter that determines the condition for the discount includes, but not limited to, a number of users having a particular discount, a discount model, and resource selection criteria (e.g., a type of cloud service, a billable category, a region, and the like). The discount model may refer to a flat discount or a tiered discount.

Furthermore, rule extractor 158 may categorize the historical billing rules along with an associated parameter into a set of groups. In an example, each group includes at least one historical billing rule related to a billable category. The billable category may indicate a type of an infrastructure object to be consumed in the cloud service. For example, license keys that cloud service providers deploy may have different billing characteristics. In this example, the license keys can be indicated as billable by defining the billable category such as compute charges, storage charges, data transfer charges, application programming interfaces (API) request, and the like. Further, rule extractor 158 may assign a unique identifier and a handler to each of the set of groups. The handler associated with a group may be a program or a mathematical logic to apply the historical billing rules in the group. Further in operation, discount predictor module 112 may evaluate the set of groups using an associated handler to determine the discount type and the discount associated with the discount type that matches the variation between the actual bill and the expected cost.

In some examples, the functionalities described in FIGS. 1A and 1B, in relation to instructions to implement functions of discount predictor module 112, self-learning module 152, line-item comparator 154, discount mapper 156, rule extractor 158, and any additional instructions described herein in relation to the storage medium, may be implemented as engines or modules including any combination of hardware and programming to implement the functionalities of the modules or engines described herein. The functions of discount predictor module 112, self-learning module 152, line-item comparator 154, discount mapper 156, and rule extractor 158 may also be implemented by a respective processor. In examples described herein, the processor may include, for example, one processor or multiple processors included in a single device or distributed across multiple devices.

Examples described herein may be implemented in a cloud service management platform such as CloudHealth, vRealize Operations and vRealize Business. With the examples described herein, the cloud cost reporting on such products can be automated with enterprise discounts plugged in, while requiring minimal inputs from the user. Thus, examples described herein significantly reduce the tenant onboarding friction points such as time to onboard a tenant, increased set of features (e.g., rightsizing) that could be supported with no effort, and the like.

FIG. 2 is a block diagram of another example system 200, depicting a discount mapper 156 to predict a discount corresponding to consumption of a cloud service. For example, similarly named elements of FIG. 2 may be similar in function and/or structure to elements described in FIG. 1B. As shown in FIG. 2, knowledge base 106 includes rate card application programming interfaces (APIs) 202, processed bills 204, and billing rules 206. Rate card APIs 202 may be used to download pricing information, like the charges for virtual machine usage, cloud storage usage, and the like. In an example, rate card APIs 202 may be used to access or download line-item prices with public rates 208. Processed bills 204 may include billed line-items 210. Billing rules 206 may include inferred discounts 212.

Further, line-item comparator 154 may compare line-item prices with public rates 208 and billed line-items 210 to determine modified line items 214 (i.e., variations in the line-items). Furthermore, rule extractor 158 may generate a discount catalogue 216 based on inferred discounts 212. In an example, rule extractor 158 may extract historical billing rules 206 defined in the cloud computing environment and generate discount catalogue 216 including distinct types of the historical billing rules defined by different customers for the cloud computing environment. Each type of historical billing rule corresponds to a type of discount offered by the cloud service provider.

Furthermore, discount mapper 156 communicatively connected to line-item comparator 154 and rule extractor 158. During operation, discount mapper 156 may predict a discount associated with consumption of a cloud service based on modified line-items 214 and discount catalogue 216 as described below.

In an example, line-item comparator 154 uses a data processing system (e.g., a spark-based processing system) to evaluate cost and usage data of the customers. A dataset (e.g., line-item prices with public rates 208 and billed line-items 210 referred to as a billing dataset) includes cost values inclusive of enterprise discounts applied by the cloud service provider. The usage and consumption values may be available for each billable category. Thus, the dataset may provide expected and actual variations at a granular level. For example, consider an original dataset as shown in equation (1), where m represents a measure column (e.g., a billed cost column) and d represents a dimension line item.

LineItemId,m1 [symbol] ,m2 [symbol] ,billedcost [symbol] . . . mn [symbol] ,d1,d2,d3, . . . dn (1)

For querying billed line-items 210 (e.g., rows) in the dataset to identify usage values and invoking calculation of undiscounted prices using the public rate cards, a pricing service with relevant parameters based on a type of service and billable category may be invoked. Further, the pricing service may provide the undiscounted values that would have been billed for a given usage amount, for that line item in absence of enterprise discounts as shown in equation (2). These values may be then appended as an extra column named like “undiscounted_costs” to be used later for any kind of ad-hoc queries involving aggregation or roll-ups (e.g., like getting the undiscounted costs by a given cloud service across all billable categories) as required by a discount mapper 156. As shown in equation (2), billedcost [symbol] represents original cost column and billedcost [symbol] represents undiscounted cost column for the cost measure m in a new bill.

LineItemId,m1 [symbol] ,m2 [symbol] ,billedcost [symbol] . . . mn [symbol] ,billedcost [symbol] ,d1,d2,d3, . . . dn (2)

Further, for each line-item, a new column containing the difference between the expected bill and the actual bill may be added, which may determine the total cost value of the discount provided for that line-item as shown in below equation (3).

LineItemId,m1 [symbol] ,m2 [symbol] ,billedcost . . . mn [symbol] ,undiscounted_cost,d1,d2,d3, . . . dn,discount value (3)

Furthermore, irrelevant line-items such as line-items involving negative values like explicit credits, carry-over-month discount, and the like may be discarded as they are not considered to evaluate the discounts.

In an example, rule extractor 158 processes billing rules (e.g., which may be created historically over a period of time) set in the could computing environment. Further, rule extractor 158 may generate discount catalogue 216 including different types of billing rules set by different customers for the cloud service. Discount catalogue 216 may correspond to the different kinds of discounts given by the cloud provider to different customers (e.g., irrespective of the discount value) and therefore discount catalogue 216 may act as a reference data for discount predictor module 112 to predict the discounts. As the number of customers increases, the dataset may become exhaustive, which enhances an accuracy of the discount prediction. An example discount catalogue 216 may include information such as a number of customers having the discounts, a type of the discount (e.g., a flat or tiered), criteria for the discounts (e.g., an instance type, a region, and the like), and the like which may be considered while predicting the discount (e.g., by discount predictor module 112).

Rule extractor 158 may collect the distinct types of discounts offered by the cloud service provider to the customers. Since majority of the discounts may be similar in type to what the cloud service provider is providing to their customers, though the amount can vary, the billing rules may be categorised into two distinct types as described below.
a. Basic discount or flat discount that may correspond to a flat percentage discount given in a cloud service, a region, and the like.
b. Tiered discount that may correspond to preferential rates provided by the cloud provider on exceeding a certain tier of usage. For example, 10% discount on S3 storage costs beyond 1000 TB, 15% on storage beyond 2000 TB, and the like.

Further, rule extractor 158 may collect relevant parameters that determine the conditions for the discount such as a region, billable categories, cloud service corresponding to the discount, and the like. Further, billing rules applicable to a billable category may be grouped together with filters, and hence a single discount identifier (ID) may exist for each unique combination of usage category and other filters. Thus, the billing rules may be used to verify the presence of any billing rule that could have been applied to arrive at the predicted discount values. For example, below table 1 shows a section of the sample billing rules extracted from the existing billing rules.

TABLE 1

| | Matching billing | Service | Billable | Discount | Discount | Filter-1 | Filter-2 |
|---|---|---|---|---|---|---|---|
| ID | rules | name | category | model | handler | region | region |
| d1 | 21% discount | AWS S3 | Storage | Fixed | S3_{—} | All | |
| | on S3, | | charges | | handler- | | |
| | 10% discount | | | | fixed | | |
| | on a few | | | | | | |
| | services, | | | | | | |
| | 13% discount | | | | | | |
| | on S3 storage | | | | | | |
| | charges | | | | | | |
| d2 | 10% discount | Aws S3 | Storage | Fixed | S3_{—} | US- | Amazon |
| | on S3 glacier | | charges | | handler- | east- 1, | Glacier |
| | storage in | | | | fixed | US- | |
| | some regions | | | | | east- 2 | |
| d3 | 10% discount | AWS S3 | API | Tiered | S3_{—} | * | Select- |
| | on some | | request | | handler- | | Scanned, |
| | operations | | | | tiered | | Select- |
| | | | | | | | Returned |

As shown in table 1, the discounts may have specific discount handlers, which may be a piece of code or mathematical logic that determines how the discount is to be applied corresponding to given actual values of the discounts. Further, the handlers may be same for a given billable category and discount type (since logic for calculation is same), and therefore a significantly limited number of handlers may be required. For example, in case of the fixed discount on a cloud service (i.e., Amazon Simple Storage Service (AWS S3)), if x denotes the fixed discount, and undiscounted cost denotes the AWS S3 costs for storage billable category, then the discounted cost is computed as shown in equation (4).

$$discounted\_cost = undiscounted\_cost * \frac{x}{100} \qquad ( 4 )$$

Further, in case of tiered discounts, the discounted costs can be calculated for each tier using the above equation (4) and then the discounted costs of the tiers may be summed up to get a total discounted cost as shown in equations (5) and (6).

$$discounted\_tier {\_cost}_{t} = undiscounted\_tier {\_cost}_{t} * \frac{x}{100} \qquad ( 5 )$$

$$discounted\_cost = {\sum }_{t} discount\_tier {\_cost}_{t} \qquad ( 6 )$$

Furthermore, the discount handlers with the above discount cost calculation may be saved to a persistent storage such as a database and kept updated from time to time based on new rules being configured by the customers either directly or via the discounts predicted by discount predictor module 112.

In an example, the calculation of undiscounted costs is a cloud and service dependent logic and is available in the cloud service management platform via associated pricing service. In this scenario, some services can be trivial as depicted in below equation (7).

undiscounted cost=usage count*public rates (7)

However, in case of other cloud services such as AWS Elastic Computing(EC2), determining the discounts can include a significantly complex algorithm, which requires an aggregation of multiple billable categories, tiered calculation based on usage, applying reservation and other benefits, and the like. This is also used in line-item comparator 154 to calculate the actual bills.

Further, line-item comparator 154 may compare the actual bills of the customers against the expected costs from public rate cards to figure out the different variations in the costs. For example, the comparison of the actual bills may be performed by line-item comparator 154 which may use a spark-based processing to process the actual bills at a very detailed line-item level so that the variations may be captured not just at a service level, but at granular billable categories (e.g., data transfer costs, API requests, and the like). Further, discount mapper 156 (e.g., an attribution logic) may map the variations to one or more discount types.

In an example, discount mapper 156 evaluates various billing rules 206 in knowledge base 106 to determine suitable billing rules and associated discount values that could explain the variations in the line-items determined by line-item comparator 154. In an example:
the billable categories and services that have non-zero variations in an associated cost column of the line-items may be filtered and listed.
for each billable category, the extracted billing rules may be listed from rule extractor 158 which match the filter conditions like a region, an instance type, and the like. Each of such discounts may be provided to the customer and checked iteratively.
for each possible discount type for the given billable category, discount values (percentage) that may be provided by the discount type may be determined to cause the variation.

Further, two different methods depending on the discount model may be considered as described below. In a fixed discount method, the line-items with the billable category may be filtered using the processed billing dataset (e.g., processed bills 204). Further, the value of discrepancy with respect to the value in undiscounted cost column may be determined as shown in below equation (8). Further, invalid line-items with more than 100% variation may be discarded as such a discount cannot given by the cloud service provider unless such discount is a credit which is explicitly excluded.

$$Discrepancy {Ratio}_{l} = \frac{{undiscounted\_cost}_{l} - {billed\_cost}_{l}}{{undiscounted\_cost}_{l}} \qquad ( 8 )$$

Further, an average of the above obtained percentage discrepancy across the line-items for the billable category may be calculated to determine the fixed discount as shown in below equation (9). The average may represent the average discount value when the fixed discount is provided.

Fixed Discount_{s,c}=avg(Discrepency Ratio_{l=s,c}) (9)

In some examples, the percentage discount is same for each line-item since the billable category within all filter criteria (e.g., like region) are applied, which may be the lowest granularity of a discount possible. Therefore, a relative standard deviation (RSD) of the percent variation values may be calculated and the discount may be discarded if the RSD increases beyond a certain value which can be predetermined as shown in equation (10).

$$Relative Standard {Deviation}_{s , c} = \frac{std . dev ( {Discrepancy}_{l = s , c} )}{avg ( {Discrepancy}_{l = s , c} )} \qquad ( 10 )$$

In a tiered discount method, the tiered discounts are calculated similarly as described above with respect to the flat discount method, however the rate of discounts may change over time based on the usage. For instance, when a cumulative consumption of the cloud infrastructure crosses a certain pre-defined tier, then the rate values can be changed. In order to figure out the tiers, historical consumption values of the given billable category across hours/days or even months may be considered. In an example, the hourly rate for the consumption amount may be calculated for each observation data-point (e.g., hour, day, or the like) using the same undiscounted cost calculation formula (e.g., equation 5) used to obtain cost values of the undiscounted cost. Further, the usage point at which there is a sudden change in the billed rate values may be identified. The usage point may signify the usage tier has been reached and a different category of discount has to be applied now.

Thus, the tiers of each line-item are recorded and the discounts are calculated for each individual tier by using a fixed discount method as explained above. Note that unlike fixed discounts, discovery of tiered discounts is a continuous process as more tiers can be discovered with extended period of usage, and therefore better results can be provided depending on the amount of available historical data and evaluation time.

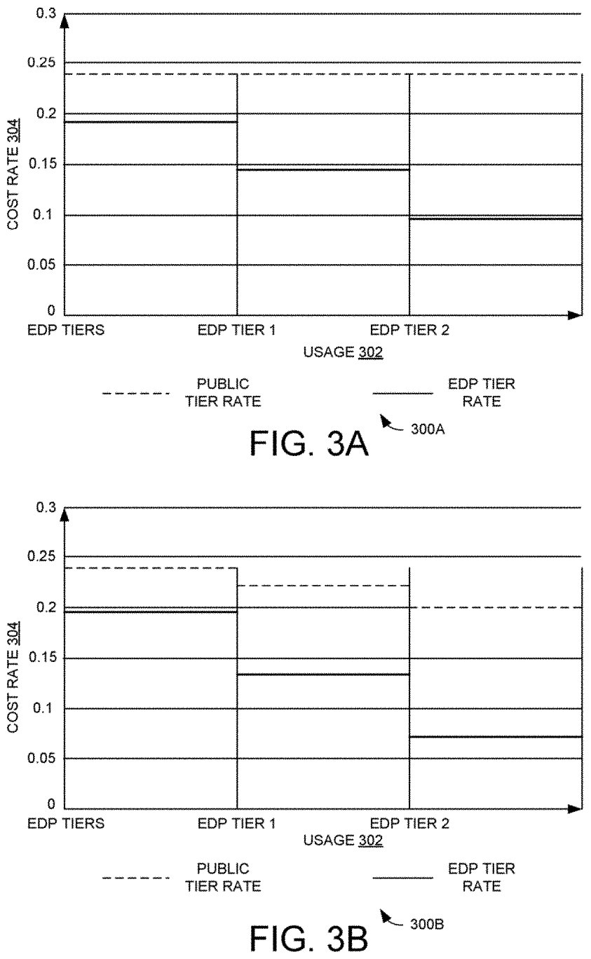

FIG. 3A shows an example graphical representation 300A of a fixed public rate and a tiered discount rate. FIG. 3B shows an example graphical representation 300B of a variable public rate and tiered discount rate. For example, FIGS. 3A and 3B show graphical representations 300A and 300B of hourly rates (e.g., 304) of the cloud service (e.g., EC2 service) under tiered discounts against certain hours of usage (e.g., 302). FIG. 3A shows a tiered discount on the fixed public hourly rate for compute resource on crossing certain thresholds, which are visible from graphical representation 300A at which sudden drop is present in the hourly rates (e.g., being charged to the customer). FIG. 3B shows the tiered discounts provided on top of tiered public rates for data transfer. In this example, the tiers for both discount and public rates are same, which may not necessarily be the case.

Referring back to FIG. 2, discount mapper 156 may return multiple types of discounts since the discounts may yield similar variations in the line-items. In such instances, the results (i.e., the discounts) may be limited by predicting a suitable discount. To predict the suitable discount, discount mapper 156 may compare mean absolute deviation (MAD) values for each of the discounts and the one with least MAD of the line-items may be selected as the suitable discount for the cloud service. Thus, discount mapper 156 may compare the discount values for a service category against the actual discount values for each and every individual line-item belonging to the service category. In case of fixed discounts, the MAD can be calculated using a below mentioned equation (11).

$$Mean Absolute Deviation = \frac{{\sum }_{l} ( Fixed {Discount}_{s , c} - Discrepancy {Ratio}_{l} )}{n} \qquad ( 11 )$$

In case of tiered discounts, same calculation may be used to obtain the tiered values for each tier and then average of the MAD of all the tiers is considered as depicted in below equation (12).

Mean Absolute Deviation=avg(Mean Absolute Deviationᵢ) (12)

In some examples where the MAD is significantly close for at least 2 discounts, then both the discounts may be presented to the customer to allow the customer to select one of the 2 discounts. For example, being close can be defined in terms of a pre-defined percentage value (e.g., less than 5%) difference between the MAD values of the two discounts.

Thus, when there are multiple possible discounts that could be applicable, the same may be presented to the customers in the form of an interactive user interface (e.g., as shown in below table 2), where the customer can view the possible discounts (e.g., which are inferred based on the bills) and verify or modify the values for the discounts or change the discounts completely. Once verified/modified by the customer, the discounts may be persisted back as billing rules 206 in knowledge base 106.

TABLE 2

| Could | | Instance | | | |
|---|---|---|---|---|---|
| Service | Category | type | Region | Amount | Type |
| AWS S3 | Storage | — | ALL | 10% | Fixed |
| AWS EC2 | Compute | M3, M4 | US- | 5% | Fixed |
| | | series | EAST-1 | | |
| AWS S4 | API calls | — | ALL | 8% after | Tiered |
| | | | | 10M | |

Thus, discount predictor module 112 may predict the discounts given to the customer by:
comparing the detailed bills of the customer containing discounted line items against their expected (e.g., undiscounted) costs calculated via the public rate cards. All the variations between the two values may be due to the discounted pricing.
mapping the variations between the two values to one or more billing rules that may be given by the cloud service provider.

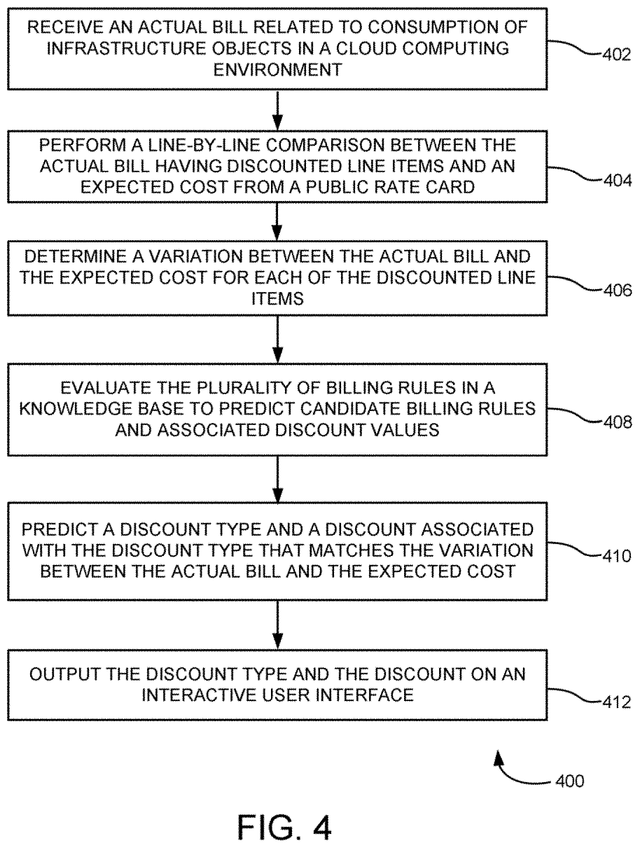

FIG. 4 is a flow diagram, illustrating an example computer-implemented method 400 for predicting a discount type and a discount for a cloud service. The processes depicted in FIG. 4 represents generalized illustrations, and other processes may be added, or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but the flow charts illustrate functional information to design/fabricate circuits, generate computer-readable instructions, or use a combination of hardware and computer-readable instructions to perform the illustrated processes.

At 402, an actual bill related to consumption of infrastructure objects in a cloud computing environment provided by a cloud service provider may be received. At 404, a line-by-line comparison may be performed between the actual bill having discounted line items and an expected cost from a public rate card.

At 406, a variation between the actual bill and the expected cost for each of the discounted line items may be determined based on the comparison. At 408, the plurality of billing rules in a knowledge base may be evaluated to predict candidate billing rules and associated discount values that match the variation in each of the discounted line items.

At 410, a discount type and a discount associated with the discount type that matches the variation between the actual bill and the expected cost may be predicted based on the candidate billing rules and the associated discount values. In an example, predicting the discount type and the discount that matches the variation between the actual bill and the expected cost may include:
filtering billable categories that have non-zero variations between the actual bill and the expected cost based on the discounted line items,
predicting a candidate billing rule that matches each of the filtered billable categories based on a parameter that determines a condition for the discount,
for each candidate billing rule, predicting a discount value that is provided by the candidate billing rule to cause the variation in a discounted line item based on a discount model, and
predicting the discount type and the discount associated with the discount type that matches the variation between the actual bill and the expected cost based on the candidate billing rules and the associated discount values associated with each of the discounted line items.

In an example, predicting the discount type and the discount associated with the discount type that matches the variation between the actual bill and the expected cost may include mapping the variation in each of the discounted line items to a candidate billing rule or a set of candidate billing rules based on the consumption of the infrastructure objects. Further, the discount type and the discount associated with the discount type that matches the variation between the actual bill and the expected cost may be predicted based on the mapping of the variations to the candidate billing rule or the set of candidate billing rules.

At 412, the discount type and the discount may be outputted on an interactive user interface. Further, a user input related to at least one of the discount type and the discount associated with the discount type may be received via the interactive user interface. In an example, the user input may verify or modify the discount type, a value of the predicted discount, or both. Further, the modified discount type, the modified discount, or both may be stored as a new billing rule in the knowledge base. Furthermore, a self-learning module may be trained to acquire knowledge from the modified discount type, the modified discount, or both and utilize the acquired knowledge for a future discount type prediction.

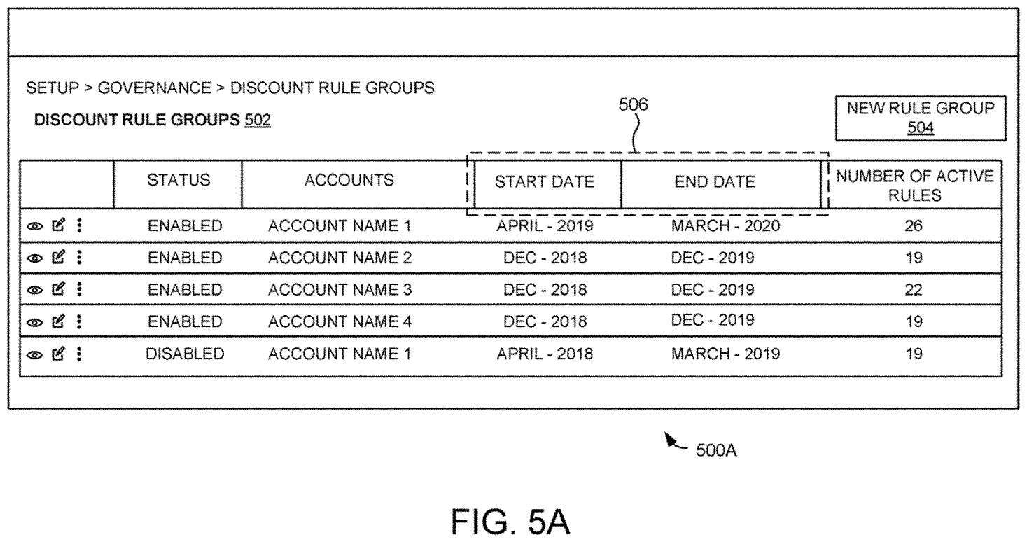

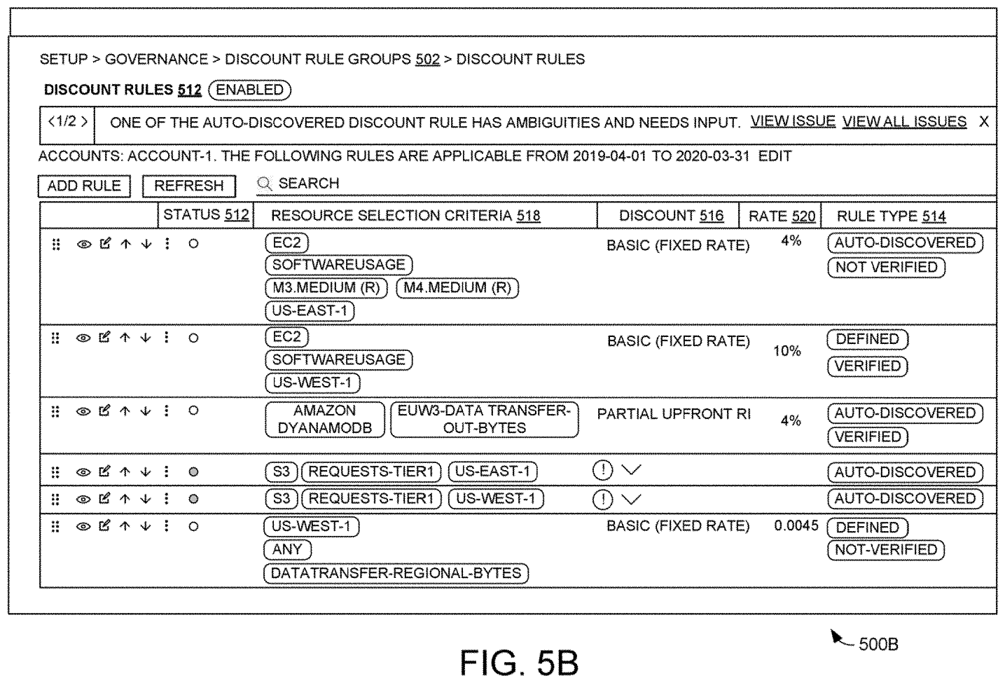

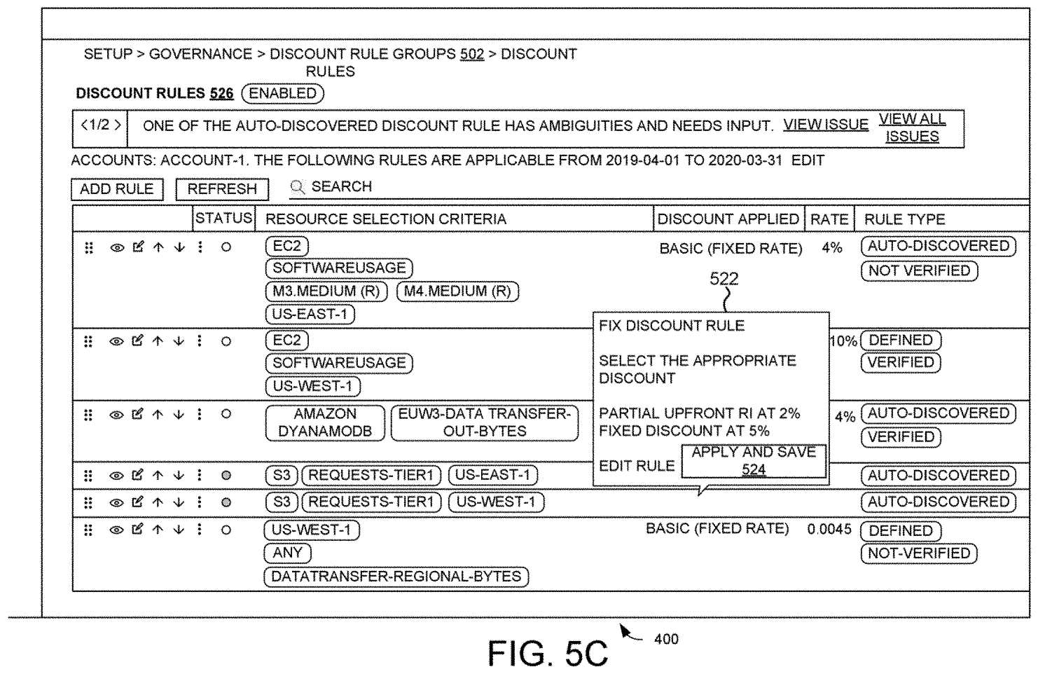

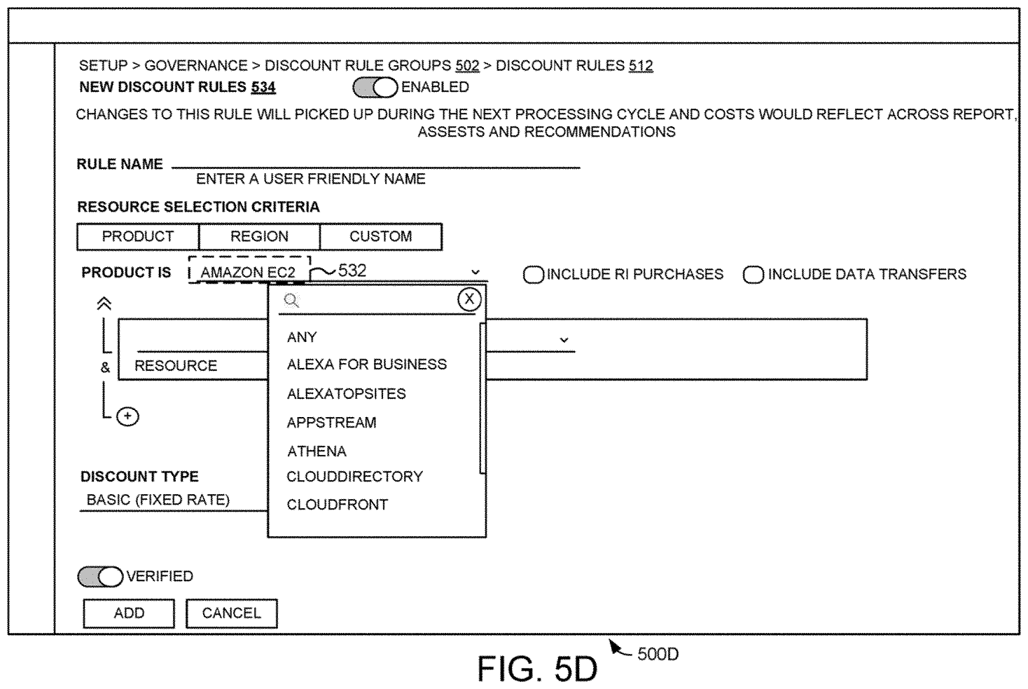

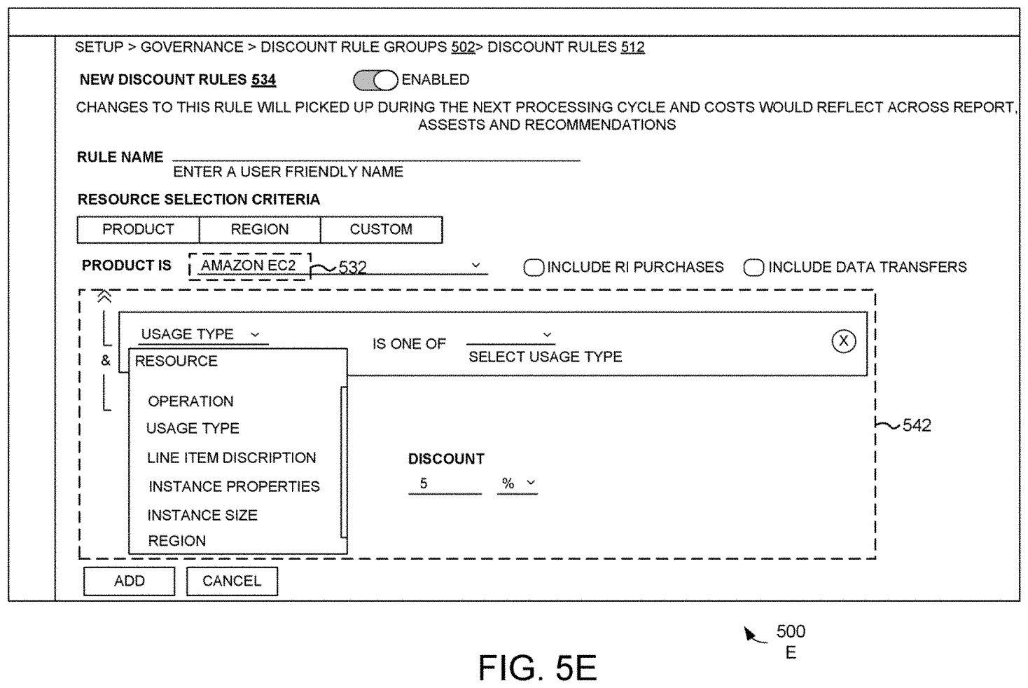

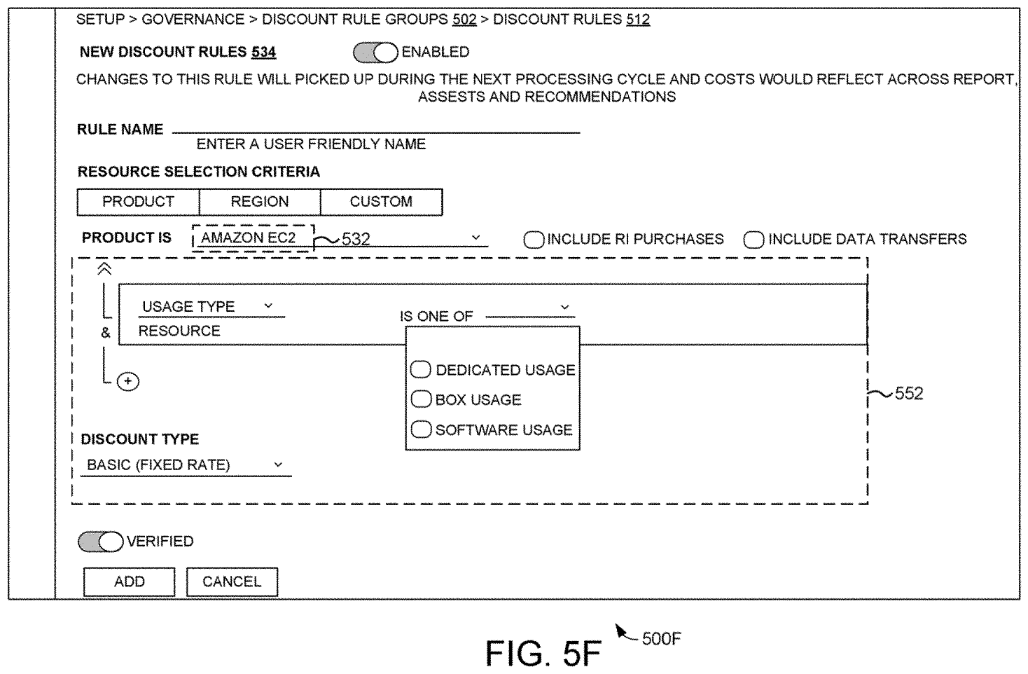

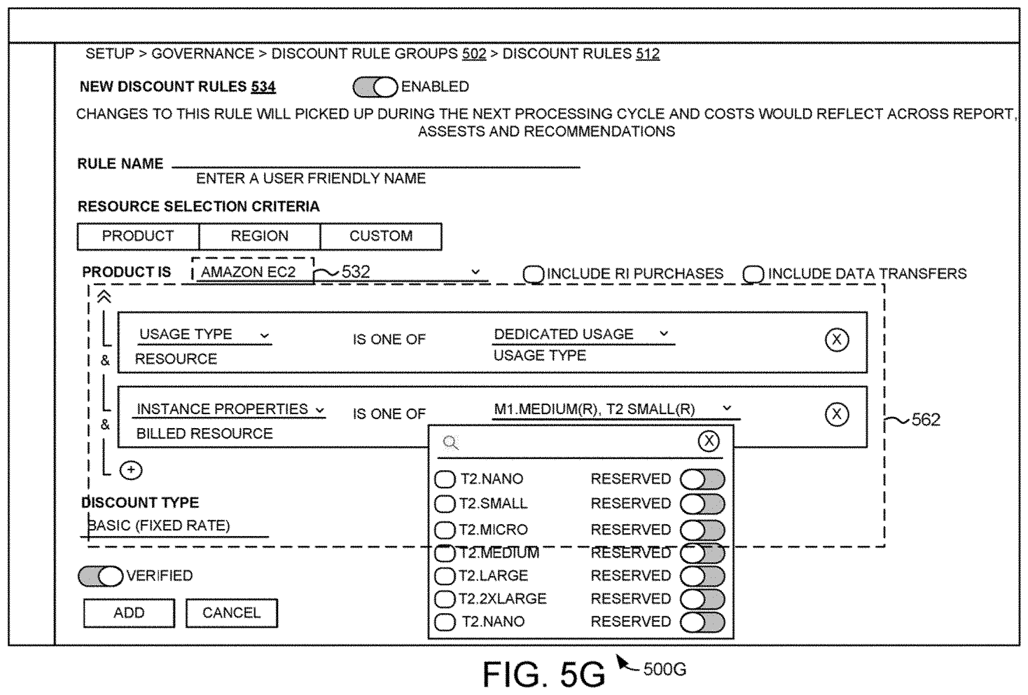

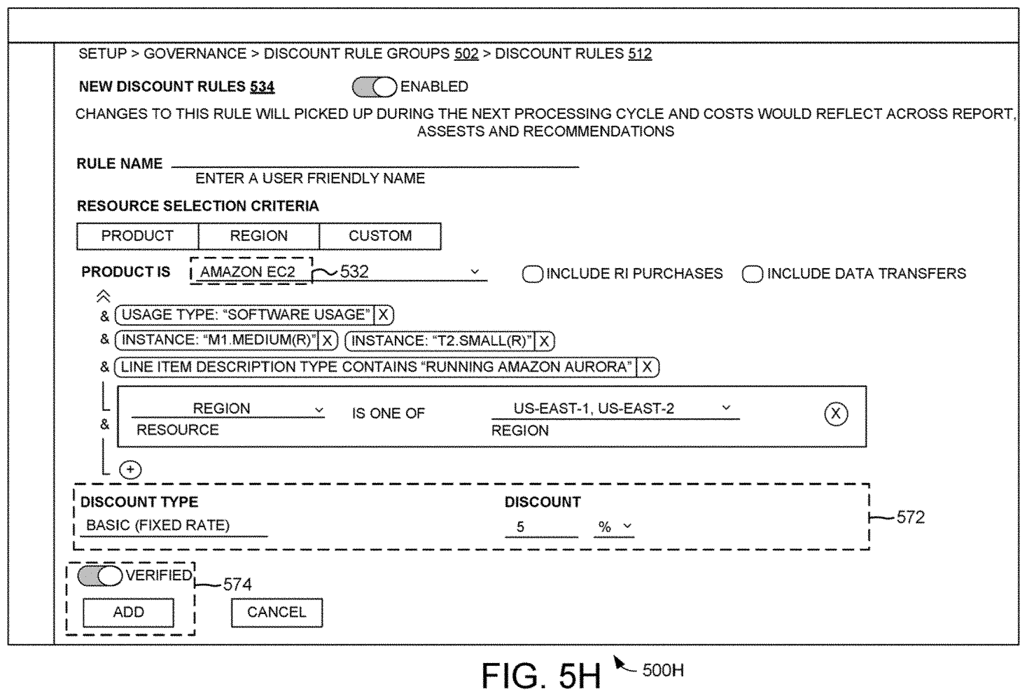

FIGS. 5A-5H are graphical user interfaces, depicting an example implementation to determine an enterprise discount in a cloud service management platform (e.g., CloudHealth), for customers with actual bills generated inclusive of discounts. FIG. 5A shows an example graphical user interface 500A, depicting an option (e.g., 504) to create a discount rule group (e.g., 502). For example, the cloud service management platform may provide graphical user interface 500A for a customer to create a group of discount rules for a cloud billing account. As shown in FIG. 5A, option 504 may be provided to create a new rule group for a specific duration of time (e.g., 506) as shown in FIG. 5A. In an example, each rule group includes multiple discount rules, which may be applied on expected costs from a public rate card to get values after considering discounts. Further, the discount rules can be navigated by clicking a rule group.

FIG. 5B shows an example graphical user interface 500B, depicting discount rules 526 corresponding to the selected rule group of FIG. 5A. Example graphical user interface 500B may list the discount rules which have been auto discovered over a period of time, along with an associated status 512 such as whether the discount rules were accepted and verified by the customer previously or not. If some rules were explicitly defined by the customer, then such rules may be marked as “defined” in a rule type 514. Also, graphical user interface 500B may present relevant information for each such rule like discount type 516 (e.g., fixed/tiered), resource selection criteria 518 (e.g., a service, a category, a region, and the like), discount value 520, and the like. In an example, when discrepancies exist in the predicted and actual values and the discounts (e.g., such as more than 100% as mentioned in exclusion criteria in algorithm) cannot be determined, then a warning message may be presented to the customer. In such cases, the undetermined values can be edited by the customer. The potential discount rule may be provided in a popup as shown in FIG. 5C.

FIG. 5C shows an example graphical user interface 500C, depicting an option to modify the discount rule. Example graphical user interface 500C presents a popup message 522 to edit the discount rule and further can be saved (as shown in 524). In an example, the discount rules can be created manually, or existing discount rules can be edited in the interactive user interface, where the details such as a service name, criteria for applying discounts like regions, billable categories, and the like about the discounts is provided. In case of auto-discovered discounts, the values may be pre-filled with the discovered values.

FIG. 5D shows an example graphical user interface 500D, depicting an option to select a product for creating a new discount rule 534. Example graphical user interface 500D provides the option to select the product (e.g., Amazon EC2) 532 for creating new discount rule 534. Further, specific filter criteria may be applied for the discount rule as shown in FIG. 5E.

FIG. 5E shows an example graphical user interface 500E, depicting an option to apply the filter criteria for the discount rule. In an example, depending on the service, specific filter criteria can also be applied. For example, for EC2 532, filter criteria 542 may be specified in from the dropdown list as shown in FIG. 5E.

FIG. 5F shows an example graphical user interface 500F, depicting an option to provide values for filter keys. For example, appropriate values for the filter keys need to be provided as well, which are available to be selected from a dropdown (e.g., as shown in 552), which may be extracted from the customer's bills, for instance. Similarly, other filter criteria may be selected as shown in FIG. 5G.

FIG. 5G shows an example graphical user interface 500G, depicting an option to select the filter criteria. For example, the filter criteria such as instance type, regions, and the like can be applied, and in some cases, more than one filter criteria can be selected as shown by 562 in FIG. 5G.

Finally, when the above-mentioned details are selected, then a discount type (e.g., fixed or tiered) may be provided as shown in FIG. 5H. FIG. 5H shows an example graphical user interface 500H, depicting an option to specify the discount type. For example, graphical user interface 500H may provide the option (e.g., as shown as 572) to specify the discount type (e.g., either fixed or tiered) along with a percentage value for the discount. Further, upon verifying and adding (e.g., as shown as 574), discount rule may be automatically applied in calculation on the public rates in the billing process.

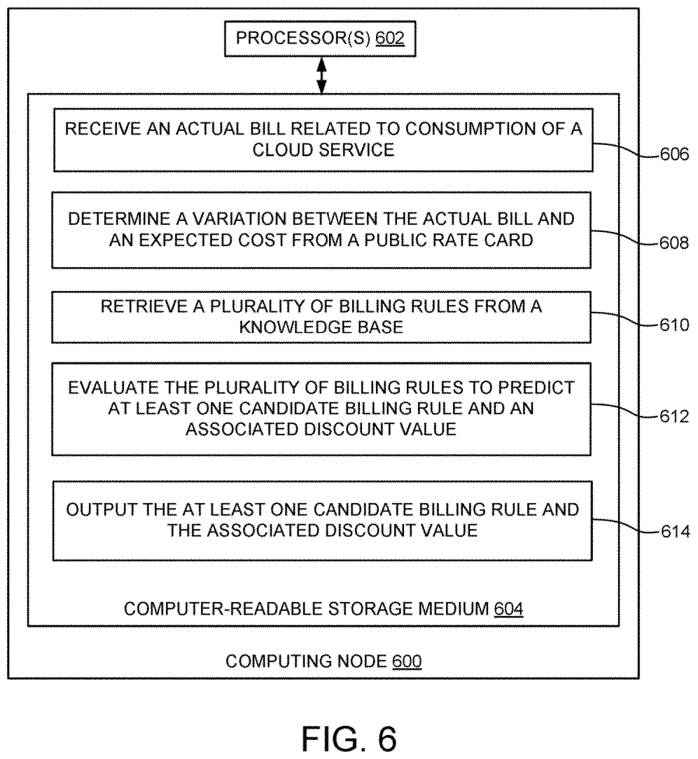

FIG. 6 is a block diagram of an example computing node 600 including non-transitory computer-readable storage medium 604 storing instructions to predict at least one candidate billing rule and an associated discount value. Computing node 600 may include a processor 602 and computer-readable storage medium 604 communicatively coupled through a system bus. Processor 602 may be any type of central processing unit (CPU), microprocessor, or processing logic that interprets and executes computer-readable instructions stored in computer-readable storage medium 604. Computer-readable storage medium 604 may be a random-access memory (RAM) or another type of dynamic storage device that may store information and computer-readable instructions that may be executed by processor 602. For example, computer-readable storage medium 604 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 604 may be a non-transitory machine-readable medium. In an example, computer-readable storage medium 604 may be remote but accessible to computing node 600.

Computer-readable storage medium 604 may store instructions 606, 608, 610, 612, and 614. Instructions 606 may be executed by processor 602 to receive an actual bill related to consumption of a cloud service in a cloud computing environment provided by a cloud service provider.

Instructions 608 may be executed by processor 602 to determine a variation between the actual bill and an expected cost from a public rate card by comparing the actual bill with the expected cost. In an example, instructions 608 to determine the variation between the actual bill and the expected cost includes instructions to:
perform a line-by-line comparison between the actual bill having discounted line items and the expected cost such that the variation between the actual bill and the expected cost is determined for each of the discounted line items,
evaluate the plurality of billing rules to predict the candidate billing rules and associated discount values that match the variations in the discounted line items, and
predict a discount type that matches the variation between the actual bill and the expected cost based on the candidate billing rules and the associated discount values.

Instructions 610 may be executed by processor 602 to retrieve a plurality of billing rules from a knowledge base. Instructions 612 may be executed by processor 602 to evaluate the plurality of billing rules to predict at least one candidate billing rule and an associated discount value that matches the variation between the actual bill and the expected cost.

Instructions 614 may be executed by processor 602 to output the at least one candidate billing rule and the associated discount value on an interactive user interface. Computer-readable storage medium 604 may further store instructions to be executed by processor 602 to:
receive a user input related to at least one of the candidate billing rule and the associated discount value via the interactive user interface, wherein the user input is to verify or modify the candidate billing rule, the associated discount value, or both,
store the modified discount type, the modified discount value, or both as a new billing rule in the knowledge base, and
utilize the stored discount type and the discount value for a future discount type prediction.

Further, computer-readable storage medium 604 may store instructions to be executed by processor 602 to:
extract historical billing rules defined in a cloud management platform of the cloud computing environment.
obtain a parameter that determines a condition for the discount.
categorize the historical billing rules along with an associated parameter into a set of groups. In an example, each group includes at least one historical billing rule related to a billable category.
assign a unique identifier and a handler to each of the set of groups, wherein the handler associated with a group is a program or a mathematical logic to apply the historical billing rules in the group. In an example, the set of groups are evaluated using an associated handler to determine a discount type that matches the variation between the actual bill and the expected cost.

Some or all of the system components and/or data structures may also be stored as contents (e.g., as executable or other machine-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A cloud service management node comprising:
a knowledge base including a plurality of billing rules for a cloud computing environment;
a processor; and
a memory coupled to the processor, wherein the memory includes a discount predictor module to:
receive an actual bill related to consumption of a cloud service in the cloud computing environment provided by a cloud service provider;
determine a variation between the actual bill and an expected cost from a public rate card by comparing the actual bill with the expected cost;
evaluate the plurality of billing rules in the knowledge base to predict a discount type and a discount associated with the discount type that matches the variation between the actual bill and the expected cost from the public rate card; and
output the discount type and the discount on an interactive user interface.

2. The cloud service management node of claim 1, wherein the discount predictor module is to output the discount type including a probable discount or multiple probable discounts on the interactive user interface.

3. The cloud service management node of claim 1, wherein the discount predictor module is to:
receive a user input related to at least one of the discount type and the discount associated with the discount type via the interactive user interface, wherein the user input is to verify or modify the discount type, a value of the discount, or both; and
store the modified discount type, the modified discount associated with the discount type, or both as a new billing rule in the knowledge base.

4. The cloud service management node of claim 3, wherein the discount predictor module comprises:
a self-learning module to:
acquire knowledge from the modified discount type, the modified discount associated with the discount type, or both; and
utilize the acquired knowledge for a future discount type prediction.

5. The cloud service management node of claim 1, wherein the memory comprises a rule extractor to:
extract historical billing rules defined in a cloud management platform of the cloud computing environment;
obtain a parameter that determines a condition for the discount;
categorize the historical billing rules along with an associated parameter into a set of groups, wherein each group comprises at least one historical billing rule related to a billable category, and wherein the billable category is to indicate a type of an infrastructure object to be consumed in the cloud service; and
assign a unique identifier and a handler to each of the set of groups, wherein the handler associated with a group is a program or a mathematical logic to apply the historical billing rules in the group.

6. The cloud service management node of claim 5, wherein the discount predictor module is to:
evaluate the set of groups using an associated handler to determine the discount type and the discount associated with the discount type that matches the variation between the actual bill and the expected cost.

7. The cloud service management node of claim 5, wherein the parameter that determines the condition for the discount is selected from a group consisting of a number of users having a particular discount, a discount model, and resource selection criteria, and wherein the discount model comprises a flat discount and a tiered discount.

8. The cloud service management node of claim 1, wherein the discount predictor module comprises:
a line-item comparator to perform a line-by-line comparison between the actual bill having discounted line items and the expected cost such that the variation between the actual bill and the expected cost is determined for each of the discounted line items, wherein each of the discounted line items is a row in the actual bill including cost of consumption of an infrastructure object in the cloud service at a granular level.

9. The cloud service management node of claim 8, wherein the discount predictor module is to evaluate the plurality of billing rules in the knowledge base to predict candidate billing rules and associated discount values that match the variations in each of the discounted line items.

10. The cloud service management node of claim 9, wherein the discount predictor module is to:
filter billable categories that have non-zero variations between the actual bill and the expected cost corresponding to the discounted line items;
predict a candidate billing rule that matches each of the filtered billable categories based on a parameter that determines a condition for the discount;
for each candidate billing rule, predict a discount value that is provided by the candidate billing rule to cause the variation based on a discount model; and
predict the discount type and the discount that matches the variation between the actual bill and the expected cost based on the candidate billing rules and associated discount values associated with each of the discounted line items.

11. The cloud service management node of claim 1, wherein the discount predictor module comprises:
a discount mapper to:
map the variation between the actual bill and the expected cost to a billing rule or a set of the plurality of the billing rules based on the consumption of the cloud service; and
predict the discount type and the discount that matches the variation between the actual bill and the expected cost based on the mapping.

12. A computer-implemented method comprising:
receiving an actual bill related to consumption of infrastructure objects in a cloud computing environment provided by a cloud service provider;
performing a line-by-line comparison between the actual bill having discounted line items and an expected cost from a public rate card;
determining a variation between the actual bill and the expected cost for each of the discounted line items based on the comparison;
evaluating the plurality of billing rules in a knowledge base to predict candidate billing rules and associated discount values that match the variation in each of the discounted line items;
predicting a discount type and a discount associated with the discount type that matches the variation between the actual bill and the expected cost based on the candidate billing rules and associated discount values; and
outputting the discount type and the discount on an interactive user interface.

13. The computer-implemented method of claim 12, further comprising:
receiving a user input related to at least one of the discount type and the discount associated with the discount type via the interactive user interface, wherein the user input is to verify or modify the discount type, a value of the discount associated with the discount type, or both; and
storing the modified discount type, the modified discount associated with the discount type, or both as a new billing rule in the knowledge base.

14. The computer-implemented method of claim 13, further comprising:
training a self-learning module to:
acquire knowledge from the modified discount type, the modified discount associated with the discount type, or both;
utilize the acquired knowledge for a future discount type prediction.

15. The computer-implemented method of claim 12, wherein predicting the discount type and the discount that matches the variation between the actual bill and the expected cost comprises:
filtering billable categories that have non-zero variations between the actual bill and the expected cost based on the discounted line items;
predicting a candidate billing rule that matches each of the filtered billable categories based on a parameter that determines a condition for the discount;
for each candidate billing rule, predicting a discount value that is provided by the candidate billing rule to cause the variation in a discounted line item based on a discount model; and
predicting the discount type and the discount associated with the discount type that matches the variation between the actual bill and the expected cost based on the candidate billing rules and the associated discount values associated with each of the discounted line items.

16. The computer-implemented method of claim 12, wherein predicting the discount type and the discount associated with the discount type that matches the variation between the actual bill and the expected cost comprises:
mapping the variation in each of the discounted line items to a candidate billing rule or a set of candidate billing rules based on the consumption of the infrastructure objects; and
predicting the discount type and the discount that matches the variation between the actual bill and the expected cost based on the mapping of the variations to the candidate billing rule or the set of candidate billing rules.

17. A non-transitory computer-readable storage medium comprising instructions that, when executed by a processor of a computing node, cause the processor to:
receive an actual bill related to consumption of a cloud service in a cloud computing environment provided by a cloud service provider;
determine a variation between the actual bill and an expected cost from a public rate card by comparing the actual bill with the expected cost;
retrieve a plurality of billing rules from a knowledge base;
evaluate the plurality of billing rules to predict at least one candidate billing rule and an associated discount value that matches the variation between the actual bill and the expected cost; and
output the at least one candidate billing rule and the associated discount value on an interactive user interface.

18. The non-transitory computer-readable storage medium of claim 17, further comprising instructions to:
receive a user input related to at least one of the candidate billing rule and the associated discount value via the interactive user interface, wherein the user input is to verify or modify the candidate billing rule, the associated discount value, or both;
store the modified discount type, the modified discount value, or both as a new billing rule in the knowledge base; and
utilize the stored discount type and the discount value for a future discount type prediction.

19. The non-transitory computer-readable storage medium of claim 17, further comprising instructions to:
extract historical billing rules defined in a cloud management platform of the cloud computing environment;
obtain a parameter that determines a condition for the discount;
categorize the historical billing rules along with an associated parameter into a set of groups, wherein each group comprises at least one historical billing rule related to a billable category, and wherein the billable category is to indicate a type of an infrastructure object to be consumed in the cloud service; and
assign a unique identifier and a handler to each of the set of groups, wherein the handler associated with a group is a program or a mathematical logic to apply the historical billing rules in the group, and wherein the set of groups are evaluated using an associated handler to determine a discount type that matches the variation between the actual bill and the expected cost.

20. The non-transitory computer-readable storage medium of claim 17, wherein instructions to determine the variation between the actual bill and the expected cost comprise instructions to:
perform a line-by-line comparison between the actual bill having discounted line items and the expected cost such that the variation between the actual bill and the expected cost is determined for each of the discounted line items;
evaluate the plurality of billing rules to predict the candidate billing rules and associated discount values that match the variations in the discounted line items; and
predict a discount type that matches the variation between the actual bill and the expected cost based on the candidate billing rules and the associated discount values.
